(19) United States
(12) Patent Application Publication
(10) Pub. No.: US 2010/0153347 A1
(43) Pub. Date: Jun. 17, 2010

(54) METHOD AND SYSTEM FOR PREVENTING CORRUPTION OF HARD DISK DRIVE FILE SYSTEM

(76) Inventors: William Charles Koester, Grosse Ile, MI (US); John Spencer Dyson, Indianapolis, IN (US)

Correspondence Address: Robert D. Shedd, Patent Operations;THOMSON Licensing LLC, P.O. Box 5312, Princeton, NJ, 08543-5312, US

(21) Appl. No.: 12/733,278

(22) PCT Filed: Feb. 19, 2008
(86) PCT No.: PCT/US08/02168

§ 371 Date: Feb. 22, 2010

Related U.S. Application Data
(60) Provisional application No. 60/965,604, filed on Aug. 21, 2007.

(51) Int. Cl. G06F 17/00; G06F 12/00; G06F 12/08

(52) U.S. Cl. 707/691; 707/687; 711/118; 707/E17.01; 707/E17.044; 711/E12.017; 707/E17.028

(57) ABSTRACT

The present principles provide methods and apparatus for preventing data corruption on a storage device by integrating a journaling file system with a cache system. To ensure journal accuracy with respect to data that is most likely to affect file system integrity, a method in accordance with an aspect of the present principles includes bypassing the cache when writing such data to a main platter of a storage device. Furthermore, to ensure overall efficiency in reading and writing data, a method in accordance with an aspect of the present principles includes writing to a cache, in addition to writing to the platter, data that has a relatively less damaging effect on file system integrity. Thus, aspects of the present principles optimally integrate a cache system with a journaling file system to provide both a robust file system integrity and an efficient reading and writing mechanism.

### TECHNICAL FIELD

The present principles generally relate to data writing on storage devices, and more particularly to methods and systems for preventing corruption of storage device file systems.

### BACKGROUND

A common problem associated with data storage is corruption of portions of a file system on a storage medium. Data corruption is often a result of interruption of data writing operations on a storage device, which may occur, for example, as a result of power loss. One approach to avoiding data corruption includes employing a journaling file system, in which changes to a storage medium, such as a hard disk drive, may be logged prior to instituting the changes. Thus, upon a power loss, the journaled changes may be “replayed,” or performed, to conform actual data structures with the journaled changes. If the journaled actions are incomplete due to a power loss and their institution would corrupt the data structures on a storage medium, then the actions are simply not replayed. Accordingly, journaled file systems may prevent data corruption on a storage medium by correcting incomplete writes that may occur during a power loss.

Another concern associated with data storage and reading includes efficiency. For example, it is often desirable to utilize the least amount of resources as possible when writing and reading data to and from a storage device. To address these concerns, a cache system comprising a relatively small portion of a storage medium is typically employed. Due to the size of a cache, reading data from a cache is often much quicker than reading data from the main platter of a storage medium. In many cache systems, data is written to the cache prior to writing data to the main platter of a storage medium. In addition, writing data to the platter may also occur in an order that is different from the order of the original commands implementing the writes. Cache systems commonly write data to the platter in such a way as to minimize scanning of a storage medium during writing operations. The order of writes on a platter in a cache system tends to be more dependent on the write locations on the storage medium rather than the order in which write commands are issued.

Thus, due to the nature of cache systems, journaling file systems often require that cache systems are disabled. To avoid corruption of data structures and to properly recover data structures after a power loss, journaling file systems rely upon writing data to a platter of a storage medium in an order consistent with the original writing commands. Accordingly, there is a need for a file system that incorporates both a journaling aspect to avoid data corruption and a cache feature to provide efficient reading and writing of data.

### SUMMARY

The present principles provide methods and systems for integrating a journaling file system with a cache system. In accordance with one aspect of the present principles, a journaling file system utilizes both a journaling aspect and a cache feature. The journaling file system may dynamically determine whether to employ a cache depending on the type of data that is written. For example, the file system may distinguish between “critical” writes and “non-critical” writes. Corruption of data associated with critical writes tends to be relatively more damaging to a file system than corruption of data associated with non-critical writes. An aspect of the present principles includes optimizing a journaling file system to include a cache feature by bypassing the cache for critical writes to thereby ensure file system integrity. In this way, aspects of the present principles may provide the benefits of both a journaling feature and a cache feature, while minimizing any negative effects typically accompanying their interaction.

One implementation of the present principles includes a method for writing data to a storage device to prevent corruption of a file system on the storage device utilizing both a journaling file system and a cache system comprising: journaling a data write; determining whether the data is critical; generating, upon determination that the data is critical, a command to write critical data to a platter of the storage device; and writing the critical data to the platter of the storage device, wherein the writing of critical data to the platter bypasses a write to a cache to ensure that a journaled state of the storage device is accurate with respect to the critical data.

Another implementation of the present principles includes a system for writing data to a storage device to prevent corruption of a file system on the storage device comprising: a main platter of a storage device; a cache; a journal including a log of changes to the storage device; a file system configured to generate commands to write data to the journal and the main platter, including a critical data write command that is generated upon determination that the data is critical data; and a storage device control module configured to write the critical data to the platter of the storage device in accordance with the critical data write command, wherein the writing of critical data to the platter bypasses a write to the cache to ensure that a journaled state of the storage device is accurate with respect to the critical data.

The details of one or more implementations are set forth in the accompanying drawings and the description below. Even if described in one particular manner, it should be clear that implementations may be configured or adapted in various manners. For example, an implementation may be performed as a method, or embodied as an apparatus configured to perform a set of operations or an apparatus storing instructions for performing a set of operations. Other aspects and features will become apparent from the following detailed description considered in conjunction with the accompanying drawings and the claims.

The invention may be advantageously used in a video recording environment, for example in a PVR, which requires accurate and timely recording of compressed digital video content.

### BRIEF DESCRIPTION OF THE DRAWINGS

The teachings of the present principles can be readily understood by considering the following detailed description in conjunction with the accompanying drawings, in which:

FIG. 1 is a block diagram of an exemplary implementation of a personal video recorder in accordance with aspects of the present principles.

FIG. 2 is a block diagram of an exemplary implementation of a system for writing data to a storage device to prevent corruption of a file system in accordance with aspects of the present principles.

FIG. 3 is a flow diagram of an exemplary implementation of a file system process employed in preventing corruption of data on a storage device in accordance with aspects of the present principles.

FIG. 4 is a flow diagram of an exemplary storage device command processing routine employed in data writing methods in accordance with aspects of the present principles.

FIG. 5 is a flow diagram of an exemplary implementation of a method for utilizing a journaling file system to repair corrupted sectors in accordance with aspects of the present principles.

It should be understood that the drawings are for purposes of illustrating the concepts of the present principles and are not necessarily the only possible configuration for illustrating the present principles. To facilitate understanding, identical reference numerals have been used, where possible, to designate identical elements that are common to the figures.

### DETAILED DESCRIPTION

The present principles provide systems and methods for writing data to a storage medium. As mentioned above, a common problem associated with data writing on a storage medium is corruption of data structures. One severe form of data corruption includes a write-splice, which occurs upon interruption of a data writing operation to a sector on a storage medium. The interruption may result from a power failure, a processor freeze or other events that prevent the completion of a writing operation. Write-splices may be characterized by a sector in which new data is written at the beginning of a sector and old data with an old checksum (sum of all bits in a sector employed to verify that there are no errors in the sector) remains at end of the sector. Write splice errors may or may not be detected, and even if detected, may require reformatting of the storage medium to correct the write-splice, resulting in loss of all recorded data. In hard disk drive systems, write-splice errors may cause a mount failure or a hanging file system volume, which often times may not even return an error code. Accordingly, because write-splice errors may generally result in loss of all recorded data, several approaches have been developed to avoid them.

Approaches to addressing write-splices include synchronous writing methods, varying the order of writes, and different forms of journaling. As mentioned above, journaling may involve logging changes to a storage medium platter prior to instituting those changes. The journal of changes may be included on the same storage medium on which data is to be written or a completely different storage medium. In many journaling file systems, the journal is stored on a ring buffer on the same storage medium in which data is ultimately written. Upon interruption of a writing operation as a result of a power failure, processor freeze, or the like, the journal of changes may be referenced to perform system recovery. For example, the journal may be replayed to complete writes to the platter that were interrupted and thereby correct a write-splice. Moreover, if writing to the journal itself is interrupted and incomplete, then the journaled changes are not replayed and the data structure integrity of the main platter is likewise intact.

To enable file system recovery subsequent to interruption of writing operations, the journal of changes should accurately reflect the state of a file system on a storage medium. Specifically, the journal should accurately include the order in which writes were performed on the main platter and/or the time in which writes have occurred. Because recovery involves replaying changes recorded in the journal, the journaling file system depends on the recorded state of the storage device being accurate; prior to replaying changes, the journaling file system presumes that certain writes have or have not been performed based on the journal. Thus, if the order of writes and/or the time that writes have been performed as recorded on the journal is inaccurate, then replay of the journaled changes may result in data corruption incurring similar problems associated with write-splice errors.

Accordingly, as discussed above, many journaling file systems require the disablement of cache systems. Cache systems, as stated above, often reorder writing operations in a manner inconsistent with the order of write commands to avoid spanning large distances between areas on a storage medium when performing write operations. Thus, writing operations are often reordered in accordance with the position of sectors on which data is written such that mounts, or other writing means, span a storage medium in an efficient manner. Additionally, in current hard disk firmware, a completion status for a write operation is returned upon writing data to a hard disk cache, even if the data has not yet been written to the hard disk platter. These features of a cache system may subvert a journaling file system's ability to recover from interruption of writing operations due to the journaling file systems dependency on an accurate journal.

Aspects of the present principles include a journaling file system that integrates a cache to provide reading and writing efficiency in addition to the system recovery capabilities permitted by journaling features. Although, implementations of the present principles are described herein with respect to a personal video recorder (PVR), it should be understood that aspects of the present principles are not limited to PVR applications.

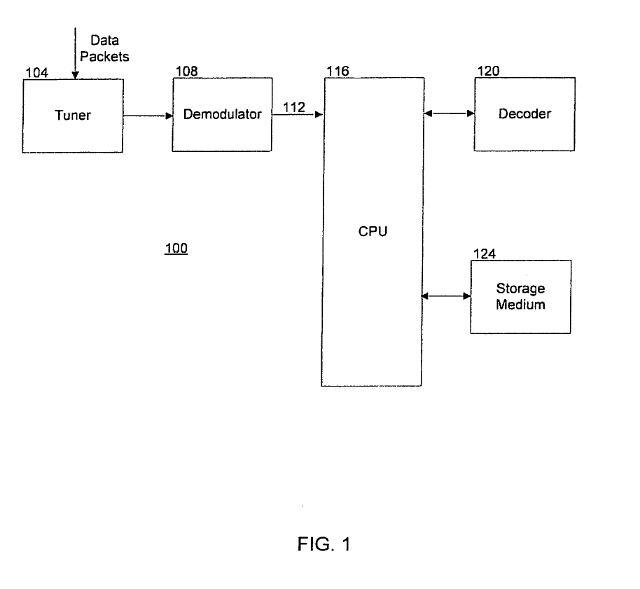

Referring now in specific detail to the drawings in which like reference numerals identify similar or identical elements throughout the several views, and initially to FIG. 1, an illustrative example of a PVR 100 implementing aspects of the present principles is depicted. The PVR 100 may include a processor 116 and a storage medium 124. The storage medium 124 may be, but is not limited to, a hard disk drive and may be utilized to store both the journal data and the data to be written in accordance with write data commands. However, as described above, in other implementations, the journaled data may be stored in a storage mechanism completely separate from the storage medium in which the data is written in accordance with write commands. The central processing unit 116 may comprise, for example a BCM 7038 C2 chip, commercially available from Broadcom®, which is a dual channel HD video/audio/graphics and personal video recording chip that incorporates a 300 MHz 64-bit CPU. The BCM 7038 C2 is a common processor employed in personal video recorders.

In one implementation of the present principles, audio/video data packets in MPEG-4 compression format received via satellite technology circuitry may be transmitted to the CPU 116 through stream 112. For example, a tuner 104 may tune to the appropriate frequency and receive the data packets. In addition, a demodulator 108 may synchronously demodulate an output signal from the tuner and provide audio/video data packets to the CPU 116 through stream 112. Thereafter, the audio/video data may be decompressed by utilizing decoder 120, which may comprise a BCM 7411 CO decoder, also commercially available from Broadcom®. The BCM 7411 CO decoder is compatible with MPEG-4 video streams. However, it should be understood that the audio/video data may be in any format known in the art, such as, for example, MPEG-2, and may be received by other means, such as, for example, via cable television transmission. Upon receipt of audio/visual data in an audio/video data stream, the CPU 116 may be configured via suitable software and hardware to implement the method steps described below.

Aspects of some PVRs that differ from some standard computing devices, such as personal computers, for example, include a fixed time constraint for reading and writing audio/video data. If such a PVR system, or any other system operating under a fixed time constraint, does not complete a transaction within the fixed time interval, the PVR moves onto the next part of the presentation and the information associated with an incomplete transaction may be either lost or discarded. The constraint is due to the desirability to timely display as much of a presentation as possible. Thus, when audio or video data arrives too late, it is discarded to prevent the PVR record-play system from breaking down. Accordingly, quick reading of data provided by a cache is desirable in a system operating under a fixed time constraint, such as a PVR, to prevent the loss of information.

Another aspect of some PVRs that differs from some standard computing devices is that the PVRs typically do not perform a proper operating system shutdown sequence, as the PVRs are normally powered down upon removal of an electric plug from an outlet by a user or upon a power outage. In standard computing devices, hard disk drives are commonly given a command to shut down to permit sufficient time to flush data from the cache to the platter and to permit read/write heads to park in a safe zone, each of which prevent data corruption and data loss. Various PVR designs have addressed the sudden power loss problem by instituting early power fail (EPF) routines. An EPF routine utilizes electrical current remaining in the PVR system subsequent to power supply loss, which may continue to run the PVR for approximately 10-40 ms. Using the remaining current, some EPF routines attempt to flush the cache and perform a controlled head park. Generally, such EPF routines often fail to complete the cache flush prior to dissipation of the remaining current. Thus, these EPF rountines typically instruct PVR drives to write data onto the main platter as the power dissipates, thereby resulting in write-splice errors, data loss and uncontrolled head parking.

In accordance with one aspect of the present principles, a special shutdown command sequence is incorporated into an EPF routine that completes the current sector write (if the system is writing), discards any additional data in the cache, and then performs a controlled head park. Data loss is often preferred over write-splice errors. As described above, write-splice errors often require disk reformatting and loss of all recorded data. In addition, PVRs have a higher tolerance for user-data loss than some standard computing devices, such as, for example, personal computers. PVR user-data normally comprises audio/video presentation data and loss of a few frames in general minimally affects the overall presentation.

Although EPF routines may reduce write splice errors, utilizing EPF routines will not completely prevent file system corruption. According to another aspect of the present principles, a journaling file system integrated with a cache system may be employed to both prevent data corruption and provide reading and writing efficiency. As described above, journaling filing systems are typically incompatible with cache systems. A journaling file system in accordance with an aspect of the present principles overcomes the incompatibility by distinguishing between critical data and non-critical data, which are described more fully below. Critical data may be characterized by data that tends to directly affect file system integrity if corrupted and has the potential to disable the operation of the file system. Moreover, critical data may be accessed and modified by a user and/or a system parameter and may be adjusted accordingly. Non-critical data may include data whose corruption is relatively harmless with regard to system integrity. In accordance with an aspect of the present principles, the cache is bypassed when writing critical data to the main platter. This aspect ensures that the journaled state of the system with respect to critical data is accurate, as the order in which critical data is written to the platter is consistent with the journaled writing order of a plurality of writes to the platter. Thus, when the journal is replayed upon interruption of writing operations, the file system may institute a proper recovery by referencing an accurate journal as described above, thereby preventing data corruption with respect to critical data.

With respect to writing non-critical data, according to another aspect of the present principles, a cache is utilized to provide reading and writing efficiency. The detrimental effects of any potential corruption resulting from utilization of the cache are minimal due to the relatively harmless effect of non-critical data corruption, as described more fully below. In addition, as described more fully below, non-critical data writes comprise a substantial majority of all writes to the main platter. Thus, bypassing the cache when writing critical data has a relatively nominal effect on the writing efficiency of the system as a whole. Accordingly, aspects of the present principles optimally integrate a cache system with a journaling file system to provide both robust file system integrity and an efficient reading and writing mechanism.

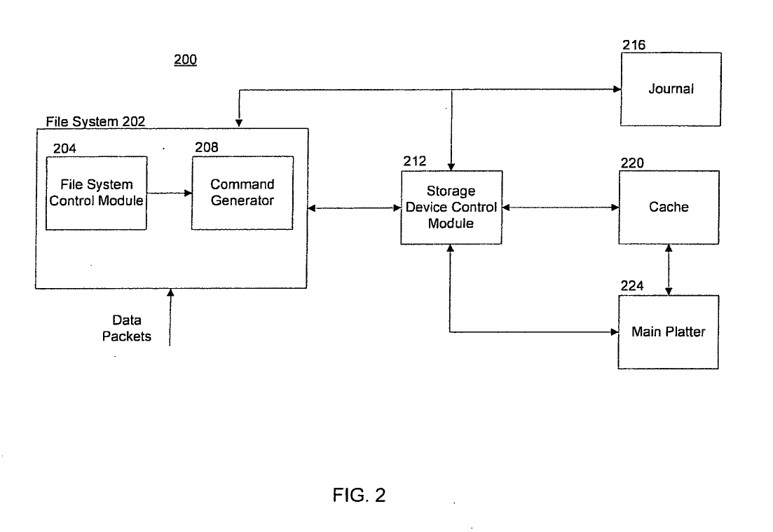

With reference to FIG. 2, an exemplary system 200 in accordance with aspects of the present principles is presented. The system 200 includes a journaling file system 202 comprising a file system control module 204 and a command generator 208. The file system control module 204 may receive and control the organization of data within a file system 202 that is stored on a storage medium. In addition, the file system control module 204 utilizes the command generator 208 to generate commands to write data to any one of a journal 216, a cache 220 and a main platter 224. The journal 216, cache 220 and main platter 224 may be included on the same storage device or different storage devices. The system 200 also includes a storage device control module 212 that processes and executes data write commands on a storage device. The system elements of FIG. 2 introduced herein are more fully described below with reference to method implementations of aspects of the present principles.

It should be noted that the functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

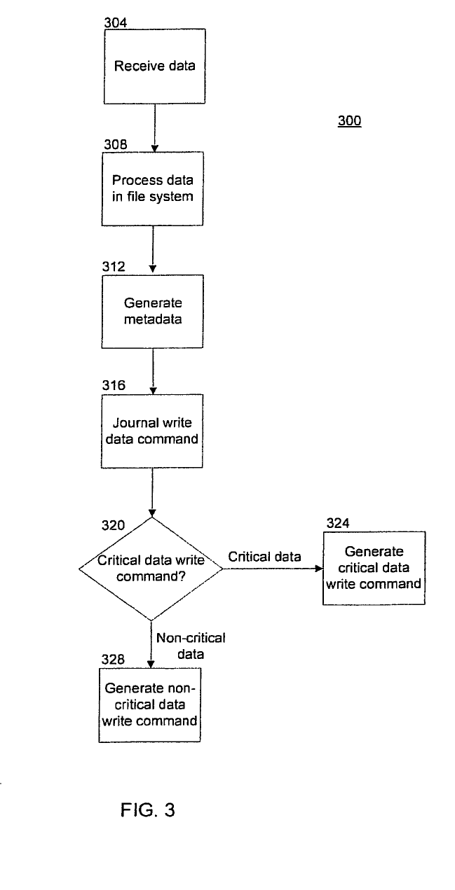

Referring now to FIG. 3 with continuing reference to FIG. 2, an exemplary journaling file system processing implementation utilized in a data writing method in accordance with aspects of the present principles is illustrated. A journaling file system processing method 300 may begin by receiving data, step 304. The data may be received by the file system 202 as packets, for example, in MPEG-4 format, as described above with respect to the PVR system of FIG. 1. Subsequently, in step 308, the data may be processed in the file system 202, wherein the file system control module 204 may determine that data is to be written to the main platter of a storage device 224, which may comprise, for example, a hard disk drive. Thereafter, metadata for the data may be generated by the file system control module 204 in step 312.

The method 300 may also comprise journaling changes to the platter of a storage device in a journal or log 216. For example, the file system control module 204 may employ the command generator 208 to generate commands to journal changes to the storage device. A change may include writing data to the main platter 224 and the write data command associated with the main platter write may be journaled in the log or journal 216, step 316. The storage device control module 212 may journal the platter write command by writing to the journal in accordance with commands received from the file system 202. In addition, as described above, the journal, or log, 216 may be stored in a ring buffer on the storage device or it may be stored on a completely different storage medium. Moreover, the journal 216, in certain implementations, may include the actual data to be written.

Upon journaling a write data command, in accordance with aspects of the present principles, the file system control module 212 determines whether the write data command corresponds to writing critical data or non-critical data, step 320. Non-critical data may comprise user-files, such as audio-video data, text, and other application information. As described above, loss of audio-video data and other user-data often have minimal detrimental effects in PVR systems. Critical data may comprise metadata, which may include either hidden or non-hidden information that the file system itself uses for finding user-data files and for internal maintenance, that is, data directed to aspects of, or maintaining, the file system rather than audio- and video data.

If it is determined that the write data command corresponds to critical data, then the command generator 208 in accordance with aspects of the present principles generates a critical data write command, step 324. Likewise, if it is determined that the write data command corresponds to non-critical data, then the command generator 208 in accordance with aspects of the present principles generates a non-critical data write command, step 328. Critical data writing commands and non-critical data writing commands are described more fully below with respect to the description of storage device command processing implementations.

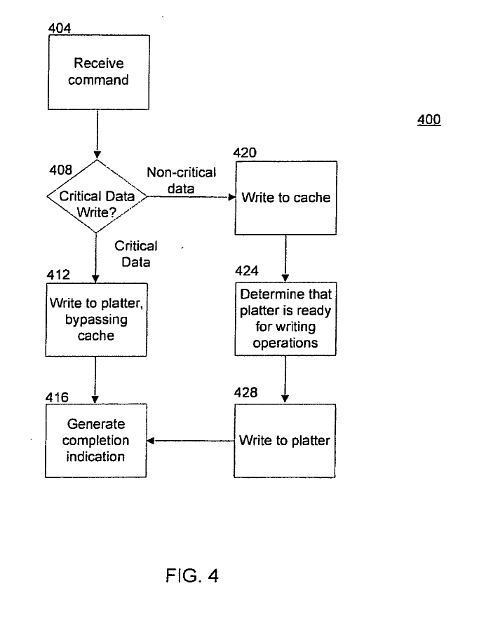

Referring now to FIG. 4 with continuing reference to FIG. 2, an exemplary storage device command processing routine 400 employed in data writing methods in accordance with aspects of the present principles is depicted. The storage device command processing routine may begin by the storage device control module 212 receiving a command from the command generator 208, step 404. The storage device control module 212 then determines in step 408 whether the command is a command to write critical data or non-critical data. Upon determination that the write data command is a command to write critical data, then the storage device control module 212 writes critical data directly to the platter 224 in step 412, bypassing a write to the cache 220. As described above, bypassing the cache 220 ensures that a journaled state of the storage device is accurate with respect to the critical data. For example, writing of critical data directly to the platter may ensure that the writing order of a plurality of writes to the platter is consistent with a journaled writing order of a plurality of writes to the platter.

After writing critical data to the platter 224, the storage device control module 212 provides a write completion indication to the journaling file system 202 in step 416. The write completion indication ensures that the journaled file system 202 accurately reflects the time the critical data was written to the platter. An accurate journal enables the file system 202 to properly recover from interruption of data writing operations, as described above. Furthermore, bypassing the cache 220 includes an additional benefit of providing more cache space for user-data, which in turn enables more efficient reading of data, as discussed above. Additionally, according to another aspect of the present principles, the system 200 may also optionally write critical data to the cache subsequent to writing the critical data to the platter 224 to permit efficient reading of the data. For example, the file system control module 204 may employ the command generator 208 to issue commands to write critical data to the cache 220 after critical data is written to the platter 224. The storage device control module 212 then writes the critical data to the cache 220 after it writes the critical data to the main platter 224.

Upon determination that the write data command is a command to write non-critical data, the storage device control module 212 writes the non-critical data to the cache 220 in step 420. Subsequently, after determining that the platter 224 is ready for writing operations corresponding to cached data, step 424, the storage device control module 212 writes non-critical data to the main platter 224 of the storage device, step 428. As discussed above, when utilizing a cache, data written to the platter is often written in an order that is not consistent with the original write commands to provide writing efficiency. Furthermore, data may be read from the cache relatively quickly due to its small size, as stated above. After writing data to the platter 224, in step 416, the storage device control module 204 provides a write completion indication to the journaling file system 202 in step 332. The methods 300 and 400 are repeated as necessary as new or different data is received by the filing system.

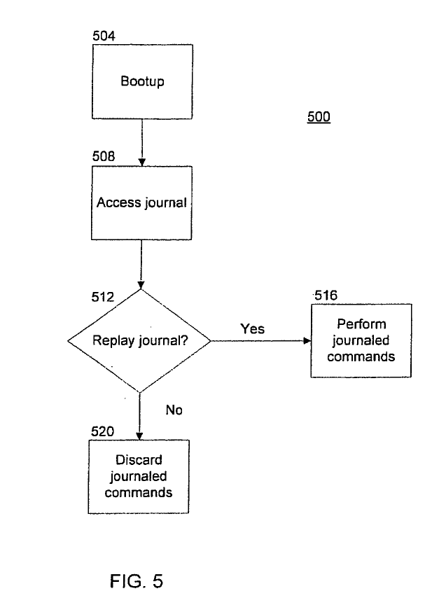

As described above, a journaling file system may be employed to prevent corruption of data on a storage device. One aspect of a journaling file system includes replaying logged commands to repair corrupted sectors that were damaged as a result of interruption of writing operations. With reference to FIG. 5 and continuing reference to FIG. 2, a method 500 for repairing at least one corrupted sector by employing the journaling file system 202 in accordance with an aspect of the present principles is illustrated. The method may begin by booting up a processor and a storage medium on which data was written, step 504, after a power failure. However, the method may also begin, for example, upon restoration of normal processing subsequent to a processor freeze or any other cause of a writing interruption. After interruption and resumption of normal processing, in step 508, the file system control module 204 accesses a journal 216 of commands, step 508. Thereafter, the file system control module 204 determines whether to replay the logged commands in the journal 216, step 512. As discussed above, the logged commands are replayed to complete writes to the platter that were interrupted. The file system performs journaled commands in step 516 after determining that writing to the platter has been interrupted. For example, the file system control module 204 may, upon determining that writing to the platter has been interrupted, employ the command generator 208 to generate commands consistent with the commands logged in the journal 216. In addition, the storage device control module 212 implements the commands by writing data to the main platter 224 or making any other changes consistent with the journal 216. If the file system control module 204 determines that a writing operation to the journal, as opposed to a writing operation to the platter, has been interrupted, then journaled commands are discarded in step 520. As discussed above, utilizing a journaling file system in this manner ensures data structure integrity of the main platter. It should be understood that although methods 300, 400 and 500 were described with reference to system 200, the methods may be implemented by other means in accordance with other aspects of the present principles.

Integration of a journaling file system with a cache system in accordance with aspects of the present principles provides both a robust file system integrity and an efficient reading and writing mechanism. As discussed above, bypassing a cache for critical data writing in a journaling file system prevents its corruption. Corruption of critical data, such as, for example, metadata, tends to be relatively more damaging to a file system than corruption of data associated with non-critical writes. As discussed above, metadata includes information that the file system utilizes to find user-data and to perform internal maintenance; its corruption has a greater detrimental effect than corruption of user-data. The processor determines whether the data is critical or not critical, and the determination may be programmed based on the particular application of the system, for example, a video recording system. Corruption of user-data is typically limited to the portion of user-data that is corrupted, while corruption of metadata may negatively affect other portions of data in addition to the corrupted metadata. Thus, although corruption of user-data may occur as a result of utilization of a cache, its detrimental effects are minimal. Accordingly, the journaling file system in accordance with aspects of the present principles provides robust protection against file system corruption despite utilizing a cache.

Moreover, the benefits of the present principles are especially evident in PVR systems. In a PVR system, corruption of non-critical data, such as encoded, encrypted audio/video information, tends to be drastically less harmful than corruption of critical data. Damaged sectors of a storage medium including audio/visual information may only appear as a small glitch in a presentation, while corrupted metadata tends to have a greater potential for disabling the file system itself.

In addition to providing substantial protection against file system corruption, aspects of the present principles also provide efficient reading and writing capability due to utilization of a cache for non-critical data. Critical data, such as metadata, typically comprise approximately less than 10% of all data writing operations, while non-critical data, such as user-data, typically comprise approximately more than 90% of all data writing operations. Thus, bypassing the cache for critical data writes has a nominal effect on reading and writing efficiency provided by the cache, as they comprise a relatively small volume of writes. Accordingly, aspects of the present principles optimally integrate a cache system with a journaling file system to provide both a robust file system integrity and an efficient reading and writing mechanism.

Journaling filing systems that may be employed to implement aspects of the present principles described above may include, for example, XFS and EXT3FS. Beneficial features of file systems such as XFS with respect to PVR applications include its ability to provide efficient writing of multiple streams of audio-visual data. File systems such as XFS have a “real-time” partition feature in which storage space is allocated in relatively large portions to provide nearly 100% of the storage device throughput without adding complexity to the application. In contrast, desktop and timesharing file systems commonly allocate small portions of storage space of a file as it is written, resulting in sub-optimally interleaved streams with relatively poor throughput.

Additionally, a program interlace specification that may be utilized to implement aspects of the present principles include ATA7. ATA7 comprises Self-Monitoring, Analysis, and Reporting Technology (SMART) features, Forced Unit Access (FUA) features, and time limited commands, each of which may particularly suit a PVR. For example, SMART features may be employed by a file system to determine the operating condition of a storage device, temperature monitoring of the storage device. Moreover, SMART features may be used to predict near future disk drive failures in hard disk drive storage devices.

FUA commands ensure that unit data is transferred to or from device media before command completion even if caching is enabled. Thus, FUA commands implement write requests that bypass, or nearly bypass, a cache. A journaling file system in accordance with aspects of the present principles may employ FUA commands to increase the likelihood of successfully writing critical data without appreciably affecting the writing of less critical data. For example, FUA commands may be utilized to implement the writing of critical data, such as file system metadata, directly to the platter in accordance with aspects of the present principles while continuing to use traditional write commands for less critical data.

Furthermore, the time limited command set included in ATA7 may be employed to institute the fixed time constraint of a PVR system. As described above, a PVR system operates under a fixed time constraint in that information is lost or discarded if the PVR does not complete a transaction within the fixed time interval. Storage mediums included in some standard computing devices, such as, for example, personal computers, conduct many time-consuming data read and write retries upon encountering an input/output or disk surface error. Utilizing such systems in PVR devices have the potential to severely disrupt a multimedia stream where an error may only be present on a single sector. The time limited commands of ATA7 may impose the fixed time constraint to abandon such retries within the time constraint. As described above, the PVR system attempts to timely display as much of a presentation as possible. Accordingly, the detrimental effect of omitting data within a sector or small group of sectors including an error is negligible and oftentimes is practically imperceptible during the display of an audio video presentation.

Features and aspects of described implementations may be applied to various applications. Applications include, for example, avoidance of data corruption on standard computing devices, personal digital assistants, MP3 players, video file players and other devices. However, the features and aspects herein described may be adapted for other application areas and, accordingly, other applications are possible and envisioned. Additionally, data may be sent and received by an apparatus in accordance with aspects of the preset principles over (and using protocols associated with) fiber optic cables, universal serial bus (USB) cables, small computer system interface (SCSI) cables, telephone lines, digital subscriber line/loop (DSL) lines, satellite connections, line-of-sight connections, and cellular connections.

The implementations described herein may be implemented in, for example, a method or process, an apparatus, or a software program. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processing devices also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data transmission and reception. Examples of equipment include video coders, video decoders; video codecs, web servers, set-top boxes, laptops, personal computers, and other communication devices. As should be clear, the equipment may be mobile and even installed in a mobile vehicle.

Additionally, the methods may be implemented by instructions being performed by a processor, and such instructions may be stored on a processor-readable medium such as, for example, an integrated circuit, a software carrier or other storage device such as, for example, a hard disk, a compact diskette, a random access memory (“RAM”), or a read-only memory (“ROM”). The instructions may form an application program tangibly embodied on a processor-readable medium. As should be clear, a processor may include a processor-readable medium having, for example, instructions for carrying out a process.

As should be evident to one of skill in the art, implementations may also produce a signal formatted to carry information that may be, for example, stored or transmitted. The information may include, for example, instructions for performing a method, or data produced by one of the described implementations. Such a signal may be formatted, for example, as an electromagnetic wave (for example, using a radio frequency portion of spectrum) or as a baseband signal. The formatting may include, for example, encoding a data stream, packetizing the encoded stream, and modulating a carrier with the packetized stream. The information that the signal carries may be, for example, analog or digital information. The signal may be transmitted over a variety of different wired or wireless links, as is known.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are within the scope of the following claims.

1. A method for writing data to a storage device utilizing both a journaling system and a cache system, comprising:
receiving a command to write data onto a storage medium;
journaling a data write in response to the command;
determining whether the data is critical data; and
upon determining that the data is critical, bypassing a write to a cache when writing the data to the storage medium to thereby ensure that a journaled state of the storage device is accurate with respect to the critical data.

2. The method of claim 1 further comprising the steps of:
upon determining that the data is non-critical data, writing the data to the cache and writing the data to the storage medium.

3. The method of claim 1 further comprising the step of:
journaling a write completion indication upon writing critical data to the platter to ensure that the journaled file system reflects a time the critical data was written to the storage medium.

4. The method of claim 1, wherein critical data corresponds to data directed to management of a file system, and non-critical data corresponds to compressed audio/video data.

5. The method of claim 4, wherein critical data includes metadata.

6. The method of claim 4, wherein the method steps are performed within a personal video recorder.

7. The method of claim 1, further comprising the step of:
writing critical data to the cache subsequent to completing the writing of the critical data to the storage medium.

8. The method of claim 1, further comprising the step of:
performing journaled commands to repair at least one corrupted sector on the storage device subsequent to an interruption of writing operations.

9. A system for writing data to a storage device, comprising:
a cache including data to be written to a storage medium;
a journal including a log of changes; and
a storage device control processor configured to receive a command to write data onto the storage medium, determine whether the data is critical data, and if the data is critical, control the writing of the data to the storage medium by bypassing the cache when the critical data is written to the storage medium, to thereby ensure that a journaled state of the storage device is accurate with respect to the critical data.

10. The system of claim 9, wherein
the storage device control processor is further configured to write non-critical data to the cache and to write non-critical data to the storage medium.

11. The system of claim 9, wherein the storage device control processor is further configured to journal a write completion indication upon writing critical data to the storage medium to ensure that the journaled file system accurately reflects the time the critical data was written to the storage medium.

12. The system of claim 9, wherein critical data corresponds to data directed to management of a file system, and non-critical data corresponds to compressed audio/video data.

13. The system of claim 9, wherein the critical data comprises metadata.

14. The system of claim 9, wherein the system is included within a personal video recorder.

15. The system of claim 9, wherein the storage device control processor is further configured to write the critical data to the cache upon completion of the writing of the critical data to the storage medium.

16. The system of claim 9, wherein the storage device control processor is further configured to perform journaled commands to repair at least one corrupted sector on the storage medium subsequent to interruption of writing operations in accordance with file system commands.

17. A digital video recording apparatus, comprising:
a storage medium;
a digital video signal source for providing a program signal;
means for processing the program signal to provide a compressed signal;
means for storing the compressed audio/video signal onto the storage medium;
a cache for storing data to be written to a storage medium;
a journal for storing a log of changes; and
a processor configured to receive a command to write data onto the storage medium, determine whether the data is critical data, and if the data is critical, control the writing of the data to the storage medium by bypassing the cache when the critical data is written to the storage medium, to thereby ensure that a journaled state of the storage device is accurate with respect to the critical data, the critical data corresponding to data directed to management of a file system, and non critical data corresponding to audio/video signal.

18. The apparatus of claim 17, wherein the cache and the journal are stored on the storage medium.

19. The apparatus of claim 17, wherein the processor is configured to write critical data in the cache upon completing the writing of the critical data on the storage medium.

20. The apparatus of claim 17, wherein the critical data comprises metadata.
